(19) United States
(12) Patent Application Publication
(10) Pub. No.: US 2012/0188702 A1
(43) Pub. Date: Jul. 26, 2012

(54) NOTEBOOK COMPUTER

(75) Inventor: ZHENG-HENG SUN, Tu-Cheng (TW)

(73) Assignee: HON HAI PRECISION INDUSTRY CO., LTD., Tu-Cheng (TW)

(21) Appl. No.: 13/069,547

(22) Filed: Mar. 23, 2011

(30) Foreign Application Priority Data
Jan. 24, 2011 (CN) 201110025757.2

(51) Int. Cl. G06F 1/16

(52) U.S. Cl. 361/679.27

(57) ABSTRACT

A notebook computer includes a base and a display pivotably connected to the base. A number of skidproof members are attached to side surfaces of the display and the base opposite to the pivotable connection, for stably standing the notebook computer in an upright position.

### BACKGROUND

1. Technical Field

The disclosure relates to a notebook computer.

2. Description of Related Art

Although notebook computers may be considered convenient and small, when not in use, a notebook computer just takes up space when horizontally set on a desk.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of a notebook computer.

FIG. 2 is a cross-sectional view of a part of FIG. 1, taken along the line II-II.

FIG. 3 is a using state of the notebook computer of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

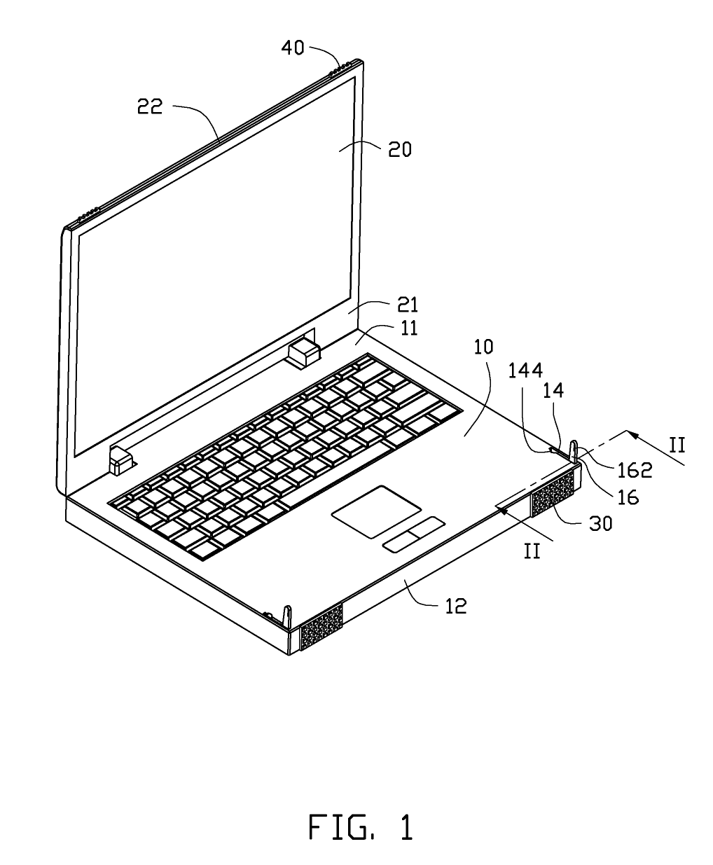

Referring to FIG. 1, an exemplary embodiment of a notebook computer includes a base 10 and a display 20. The base 10 includes a first side 11, and a second side 12 opposite to the first side. The display 20 includes a first side 21, and a second side 22 opposite to the first side 21. The first side 21 of the display 20 is pivotably connected to the first side 11 of the base 10.

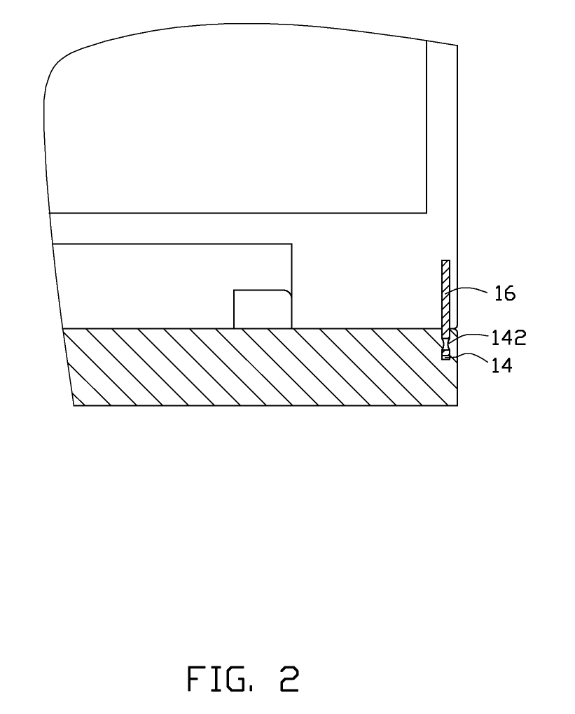

Also referring to FIG. 2, the base 10 defines two receiving slots 14 in opposite ends of the second side 12. Two supporting members 16 are received in the corresponding receiving slots 14. Two tabs 142 are respectively formed extending from two inner surfaces of each receiving slot 14. Two cutouts 144 are defined in an upper surface of the base 10, each communicating with a corresponding receiving slot 14. One end of each supporting member 16 is pivotably attached to the tab 142 in the corresponding receiving slot 14. A handle 162 is formed on one side of each supporting member 16. In use, the supporting members 16 are pivoted to be received in the receiving slots 14 respectively. The handles 162 of the supporting members 16 are received in the cutouts 144 of the receiving slots 14 respectively.

A plurality of skidproof members 30 are attached to a side surface at the second side 12 of the base 10. The skidproof members 30 can be made of rubber. The skidproof members 30 can be attached to the side surface at the second side 12 of the base 10 by adhesive.

A plurality of skidproof members 40 are attached to a side surface of the second side 22 of the display 20. The skidproof members 40 can be made of rubber. The skidproof members 40 can be attached to the side surface of the second side 22 of the display 20 by adhesive.

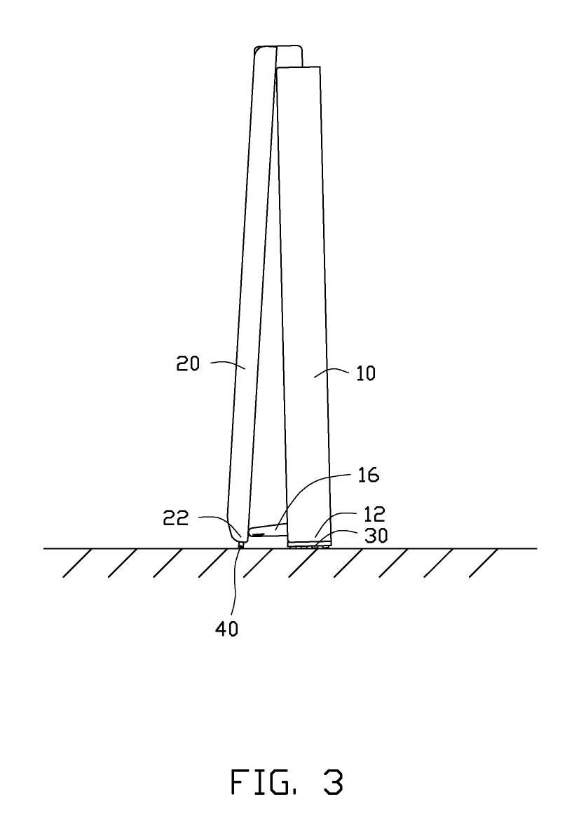

Referring to FIG. 3, when the notebook computer is not in use, the handles 162 of the supporting members 16 are operated to pivot the supporting members 16 out of the corresponding receiving slots 14. The second side 12 of the base 10 and the second side 22 of the display 20 are oriented down and in contact with a supporting surface such as a desktop. The supporting members 16 resist against the second side 22 of the display 20, to space the second side 12 of the base 10 from the second side 22 of the display 20, for stably supporting the notebook computer on the desktop. The skidproof members 30 and 40 are used prevent the second side 12 of the base 10 and the second side 22 of the display 20 sliding on the desktop.

In this disclosure, when the notebook computer is not in use, the notebook computer can be stored in an upright position on the desktop, which can save space.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A notebook computer comprising:
a base comprising a first side, and a second side adjacent to the first side;
a display comprising a third side and a fourth side adjacent to the third side, the third side of the display pivotably connected to the first side of the base; and
a plurality of skidproof members attached to the fourth side of the display and the second side of the base.

2. The notebook computer of claim 1, wherein the base defines a receiving slot adjacent to the second side, a supporting member is pivotably mounted to the base and is operable to be received in or moved out of the receiving slot.

3. The notebook computer of claim 2, wherein the supporting member resists against the fourth side of the display, to space the second side of the base from the fourth side of the display, when the supporting member is pivoted to move out of the receiving slot.

4. The notebook computer of claim 2, wherein two tabs are respectively formed from two inner surfaces of the receiving slot, one end of the supporting member is pivotably attached to the tabs.

5. The notebook computer of claim 4, wherein a cutout is defined in an upper surface of the base, communicating with the receiving slot, a handle is formed on one side of the supporting member, wherein the handle is received in the cutout of the receiving slot when the supporting member is pivoted to be received in the receiving slot.

6. The notebook computer of claim 1, wherein the plurality of skidproof members are made of rubber.
